(19) United States
(12) Patent Application Publication
(10) Pub. No.: US 2026/0279832 A1
(43) Pub. Date: Sep. 17, 2026

(54) Cathodes Having Thermal-Runaway-Abatement Coatings, And Related Electrochemical Cells And Methods

(71) Applicant: SES Holdings Pte. Ltd., Singapore (SG)

(72) Inventors: Han Jiang, Woburn, MA (US); Benjamin Mastrorocco, Woburn, MA (US); Shundong Guan, Shanghai (CN); Zhengping Zhou, Woburn, MA (US); Binghong Han, Woburn, MA (US); Zhuhua Cai, Woburn, MA (US); Hong Gan, Woburn, MA (US)

(21) Appl. No.: 19/560,862

(22) Filed: Mar. 9, 2026

Related U.S. Application Data
(60) Provisional application No. 63/769,900, filed on Mar. 11, 2025.

(51) Int. Cl. H01M 4/62; H01M 4/13; H01M 4/36; H01M 10/0525; H01M 4/02

(52) U.S. Cl. CPC H01M 4/628; H01M 4/13; H01M 4/366; H01M 4/622; H01M 10/0525; H01M 2004/021; H01M 2004/028

(57) ABSTRACT

Cathodes having thermal-runaway-abatement coatings on the outer surface of the cathode-active material. In some embodiments, the coatings comprise a plurality of particles comprising at least one of a metal oxide, silicon dioxide, a silicate, an inorganic carbide, and a metal nitride, and a binder binding the plurality of particles together with one another. In some embodiments, the coating has a thickness in a range of about 1 µm to about 20 µm. Related electrochemical cells comprising cathodes having thermal-runaway-abatement coatings and related methods of making cathodes having thermal-runaway-abatement coatings are also disclosed. In some embodiments, methods of making cathodes having thermal-runaway-abatement coatings comprise applying a precursor to an outer surface of a cathode-active material using a height-controlled coating roller and drying the applied precursor under vacuum at about 120°C for about 8 hours.

### RELATED APPLICATION DATA

This application claims the benefit of priority of U.S. Provisional Application Serial No. 63/769,900, filed Mar. 11, 2025, and titled “Cathodes Having Thermal-Runaway-Abatement Coatings, and Related Electrochemical Cells and Methods”, which is incorporated by reference herein in its entirety.

### FIELD OF THE INVENTION

The present invention generally relates to the field of electrochemical cells. In particular, the present invention is directed to cathodes having thermal-runaway-abatement coatings, and related electrochemical cells and methods.

### BACKGROUND

In recent years, demand for high-performance batteries has surged, driven by the rapid growth of portable electronic devices, electric vehicles, and renewable energy storage systems. Lithium-ion batteries (LIB), which typically have graphite anodes, are limited in their theoretical capacity to about 374 mAh/g. Lithium-metal batteries (LMB), which have anodes comprising lithium metal, have a theoretical capacity of about 3860 mAh/g, which is over ten times higher than the theoretical capacity of LIBs. LMBs have therefore been considered to be the holy grail for high-energy secondary batteries and to offer promise to the realization of long-range electric vehicles (EVs), electric vertical take-off and landing aircraft (eVTOLs), and urban air mobility aircraft (UAM). However, there are still hurdles to cross before mass adoption of LMBs can be realized. One of the major challenges is LMB safety, particularly under various abusive conditions. The high energy density and reactive nature of lithium metal make LMBs unsafe to operate and susceptible to abusive conditions, potentially putting users at risk if the battery experiences thermal events such as fire or explosion.

Nickel-rich cathodes can improve energy density, capacity, and performance, but they also have poor thermal stability. Therefore, LMBs with high-nickel cathodes, such as cathodes comprising about 80% nickel, about 10% cobalt, and about 10% manganese (NCM811 cathodes) and cathodes comprising more than about 80% nickel have an even greater need for solutions that increase safety.

Abusive conditions, such as abusive heating, abusive mechanical, and abusive electrical conditions, share one common feature: heat generation. In heating abuse scenarios, heat can originate from internal and external sources. As temperature increases, certain components of batteries disintegrate and release heat. The released heat can accelerate additional side reactions, causing a chain reaction which eventually leads to battery thermal runaway. LIBs and LMBs with high-energy cathodes usually go into thermal runaway at less than 200℃ with violent thermal events, e.g., European Council for Automotive Research & Development (EUCAR) hazard level (HL) 7 events, under abusive heating conditions. Therefore, one critical step towards LMB commercialization is to enhance LMB safety (e.g., by deescalating the HL from HL 7 to HL 5 or below and increasing the temperature at which thermal runaway is triggered) under various abusive conditions.

Conventional attempts to reduce HL under abusive conditions have been unsuccessful or suffered from undesirable limitations. For example: applying a ceramic coating to the separator provides little enhancement; applying a NAFION^{®} polymer-based anode interfacial layer aimed at improving lithium deposition uniformity has a limited effect for thermal abuse since lithium melt beyond 180℃ could eventually destroy interfacial structures, regardless of deposition quality; atomic layer deposition (ALD) is challenging to control, fine-tune, and scale-up; extensive cathode particle treatment affects the long-term structural stability of cathode particles and greatly reduces energy density; particle-level coatings for cathodes are time-consuming, making them not suitable for low-cost, high-production-volume applications; incorporation of an internal non-sacrificial current limiter only applies to electrically abusive conditions, and does not work in thermally abusive conditions; temperature-responsive layers inserted in between different cell components are highly dependent on evolved gas triggered by high temperatures, and have a relatively slow response time when compared to thermal runaway reactions; and adding a safety coating in between the current collector and electrode-active materials unavoidably adds difficulty to electrode processing and negatively affects battery rate capabilities. Therefore, cost-efficient solutions suitable for mass production are still in demand for improving LMBs’ thermal stability and reducing hazardous damage when thermal events occur.

### SUMMARY OF THE DISCLOSURE

In one implementation, the present disclosure is directed to a coated cathode, which includes a cathode comprising a current collector and a cathode-active material in electrical communication with the current collector, the cathode-active material defining an inner surface and an outer surface spaced apart from one another, wherein the inner surface faces the current collector; and a coating on the outer surface of the cathode-active material, the coating consisting of: a plurality of particles comprising at least one of a metal oxide, silicon dioxide, a silicate, an inorganic carbide, and a metal nitride; and a binder binding the plurality of particles together with one another.

In another implementation, the present disclosure is directed to a coated cathode, which includes a cathode comprising a current collector and a cathode-active material in electrical communication with the current collector, the cathode-active material defining an inner surface and an outer surface spaced apart from one another, wherein the inner surface faces the current collector; and a coating on the outer surface of the cathode-active material, the coating comprising: a plurality of particles comprising at least one of a metal oxide, silicon dioxide, a silicate, an inorganic carbide, and a metal nitride; and a binder, wherein the plurality of particles are bound together by the binder; wherein the coating has a thickness that is greater than about 1 µm and less than or equal to about 20 µm.

In yet another implementation, the present disclosure is directed to an electrochemical energy-storage cell, which includes an anode; a coated cathode comprising: a cathode comprising a current collector and a cathode-active material in electrical communication with the current collector, the cathode-active material defining an inner surface and an outer surface spaced apart from one another, wherein the inner surface faces the current collector; and a coating on the outer surface of the cathode-active material, the coating comprising: a plurality of particles comprising at least one of a metal oxide, silicon dioxide, a silicate, an inorganic carbide, and a metal nitride; and a binder, wherein the plurality of particles are bound together by the binder; wherein the coating has a thickness that is greater than about 1 µm and less than or equal to about 20 µm; a porous separator disposed between the anode and the coated cathode, the porous separator electrically insulating the anode and the coated cathode relative to one another; a container that contains the anode, the coated cathode, and the porous separator; and an electrolyte in contact with the anode and the coated cathode and permeating the porous separator

### BRIEF DESCRIPTION OF THE DRAWINGS

For the purpose of illustration, the accompanying drawings show aspects of one or more embodiments of the disclosure. However, it should be understood that the scope of this disclosure is not limited to the precise arrangements and instrumentalities shown in the drawings, wherein:

FIG. 1 is a schematic example of a coated cathode according to aspects of the present disclosure;

FIG. 2A is a graph showing results from abuse testing done on a control LMB with no coating, including data showing cell voltage and cell temperature over time;

FIG. 2B is an image of a HL7 explosion that occurred during the abuse testing done on the control LMB;

FIG. 3A is a graph showing results from abuse testing done an LMB with a 4 um boehmite coating on the cathode-facing side of the separator, including data showing cell voltage and cell temperature over time;

FIG. 3B is an image from the abuse testing done on the LMB with the 4 um boehmite coating on the cathode-facing side of the separator;

FIG. 4A is a graph showing results from abuse testing done an LMB with a 4 um aluminum-oxide coating on the cathode-facing side of the separator, including data showing cell voltage and cell temperature over time;

FIG. 4B is an image from the abuse testing done on the LMB with the 4 um aluminum-oxide coating on the cathode-facing side of the separator;

FIG. 5A is a graph showing results from abuse testing done an LMB with a 2 um aluminum-oxide coating on the outer surface of the cathode-active material, including data showing cell voltage and cell temperature over time;

FIG. 5B is an image of the HL5 flame that occurred during the abuse testing done on the LMB with the 2 um aluminum-oxide coating on the outer surface of the cathode-active material;

FIG. 6 shows an example method of manufacturing a coated cathode according to aspects of the present disclosure;

FIG. 7A is an image of a coated cathode according to aspects of the present disclosure;

FIG. 7B is a surface scanning electron microscopy (SEM) scan of the coated cathode of FIG. 7A showing the coated surface of the coated cathode-active material;

FIG. 7C is a cross-sectional SEM scan of the coated cathode of FIG. 7A showing the plurality of aluminum-oxide particles, binder, and cathode-active material; and

FIG. 8 illustrates a simplified electrochemical energy-storage cell made in accordance with aspects of the present disclosure.

### DETAILED DESCRIPTION

The entire contents of the appended claims are incorporated into this Detailed Description section as if originally presented herein.

As used herein, the term “about” when used with a corresponding numeric value refers to ±20% of the numeric value, typically ±10% of the numeric value, often ±5% of the numeric value, and most often ±2% of the numeric value. In some embodiments, the term “about” can mean the numeric value itself. In certain embodiments, where applicable, the term “about” indicates the designated value(s) ± one standard deviation of that/those value(s).

As described in more detail below, an LMB may include an anode comprising lithium metal, a cathode, a porous separator located between and electrically separating the anode and the cathode, and an electrolyte permeating the porous separator and in operative communication with each of the anode and cathode. Under abusive conditions, chain reactions may be triggered in LMBs with increasing temperatures due to accumulating heat inside the LMBs. Initially, between around 120℃ to 150℃, the porous separator shrinks, exposing weak spots for internal shorting. Subsequently, the electrolyte may evaporate beyond around 150℃. Simultaneously, the anode interface disintegrates, releasing heat and reactive species. Then, at about 180℃, the lithium metal melts. Since molten lithium is far more reactive than solid lithium, this process further disrupts the LMB and its battery system. Beyond around 200℃, the cathode structure becomes unstable, releasing oxidative reactants and causing metal-ion diffusion, resulting in interactions between oxidative and reductive species within the LMB, which leads to an accelerated heat accumulation and eventually thermal runaway. To address this thermal-runaway problem and minimize or avoid the challenges outlined above with conventional attempts to reduce HL in LMBs under abusive conditions, the present disclosure is directed to cathodes having thermal-runaway-abatement coatings, and related electrochemical cells and methods.

In some aspects, the present disclosure is directed to a cathode having a coating directly on its outer surface. In particular, cathodes according to aspects of the present disclosure comprise a current collector and a cathode-active material in electrical communication with the current collector, and the coating is on the cathode-active material. In some embodiments, the coating comprises a plurality of particles and one or more binders that bind the particles together. The particles may comprise a metal oxide (such as aluminum oxide, zirconium oxide, magnesium oxide, or any other thermally stable oxide), silicon dioxide, a silicate, an inorganic carbide (such as silicon carbide or boron carbide), and/or a metal nitride (such as silicon nitride or aluminum nitride). In some embodiments, the one or more binders comprise polyvinylidene fluoride (PVDF), carboxymethyl cellulose (CMC), styrene-butadiene rubber (SBR), mechanically stable polyether ether ketone (PEEK), polyvinylpyrrolidone (PVP), and/or thermally stable polyimide (PI). In some embodiments, the cathode-active-material comprises nickel. For example, in an embodiment, the cathode-active material is a nickel-manganese-cobalt-oxide (NMC) cathode-active material comprising at least about 70%, at least about 75%, at least about 80%, at least about 85%, or at least about 90% nickel.

In some embodiments, the coating is about 0.5 µm to about 10 µm thick. In other embodiments, the coating is about 1 µm to about 20 µm thick, about 2 µm to about 10 µm thick, or about 2 µm to about 5 µm thick. In some embodiments, the coating has an areal density in a range of about 0.2 mg/cm² to 8 mg/cm²and a volumetric density in a range of about 0.5 g/cm³ to about 12 g/cm³. In other embodiments, the coating has an areal density in a range of about 0.1mg/cm² to about 10mg/cm²or about 0.5mg/cm² to about 1.5mg/cm², and a volumetric density in a range of about 0.05g/cm³ to about 100g/cm³ or about 1g/cm³ to about 5g/cm³. In some embodiments, the coating has a porosity in a range of about 20% to about 60%. In other embodiments, the coating has a porosity in a range of about 5% to about 90%, about 5% to about 45%, or about 45% to about 90%.

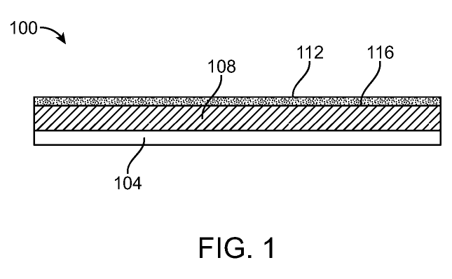

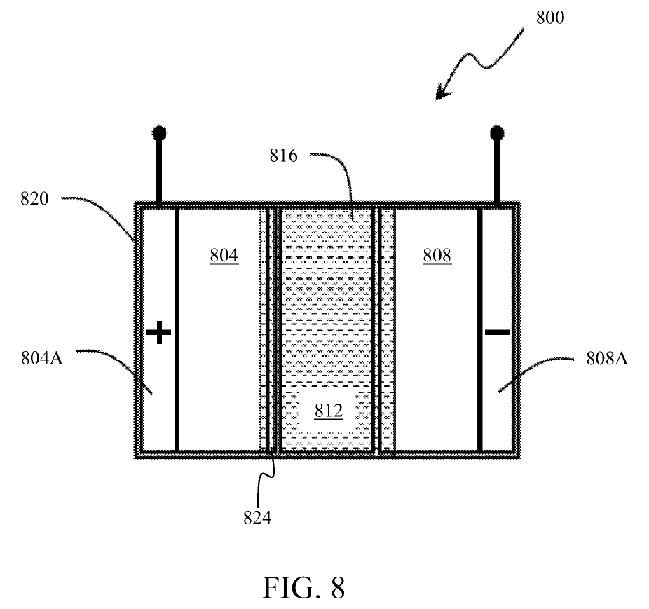

A schematic example of a coated cathode 100 of an LMB (not shown, but see, generally, the electrochemical cell 800 of FIG. 8) is shown in FIG. 1. In this example, the coated cathode 100 comprises a current collector 104, a cathode-active material 108 in electrical communication with the current collector 104, and a coating 112 on the cathode-active material that comprises a plurality of particles and one or more binders that bind the particles to one another and to the cathode-active material. The particles may comprise a metal oxide (such as aluminum oxide, zirconium oxide, magnesium oxide, or any other thermally stable oxide), silicon dioxide, a silicate, an inorganic carbide (such as silicon carbide or boron carbide), and/or a metal nitride (such as silicon nitride or aluminum nitride). Unlike some conventional safety coatings that are interlayers disposed between a current collector and an electrode-active material, the coating 112 is applied directly to an outer surface 116 of the cathode-active material 108 and is not in physical contact with the current collector 104. In other words, the cathode-active material 108 is sandwiched between the current collector 104 and the coating 112, rather than having an interlayer sandwiched between the current collector and the cathode-active material. Therefore, the limitations of interlayers, such as adding difficulty to electrode processing and negatively affecting battery rate capabilities, are minimized or avoided.

The coating 112 also has excellent physical, chemical, and electrochemical stability against commonly used electrolytes and electrode materials. By having the coating 112 on the outer surface 116 of the cathode-active material 108, the coating acts as a barrier layer between the cathode-active material and the electrolyte (not shown, but see, generally, the electrochemical cell 800 of FIG. 8), which would not be possible if the coating were an interlayer between the cathode-active material and the current collector 104. During thermal abuse, the cathode-active material 108 may be thermodynamically unstable, especially when in a fully charged state. As a result, in the absence of the coating 112, local hotspots would develop on the interface between the cathode-active material and the electrolyte, which could then trigger thermal runaway. Covering the outer surface 116 of the cathode-active material 108 with the coating 112 enhances abuse tolerance by quenching local hotspots. Furthermore, the coating 112 has good electrical insulating properties, which can effectively isolate the coated cathode 100 from molten lithium metal at high temperatures. By reducing the reactant exchange between the cathode-active material 108 and the electrolyte and molten lithium metal, the coating 112 slows down heat accumulation. The coating 112 physically contains and/or absorbs reactive species from the cathode-active material 108, making mass transfer and cross-reactions with reducing agents contained in the electrolyte much less likely.

Additionally, in some embodiments, the particles in the coating comprise metal-oxide particles having a high specific surface area that increases their interface area with the one or more binders, thus effectively enhancing density and mechanical properties of the coating.

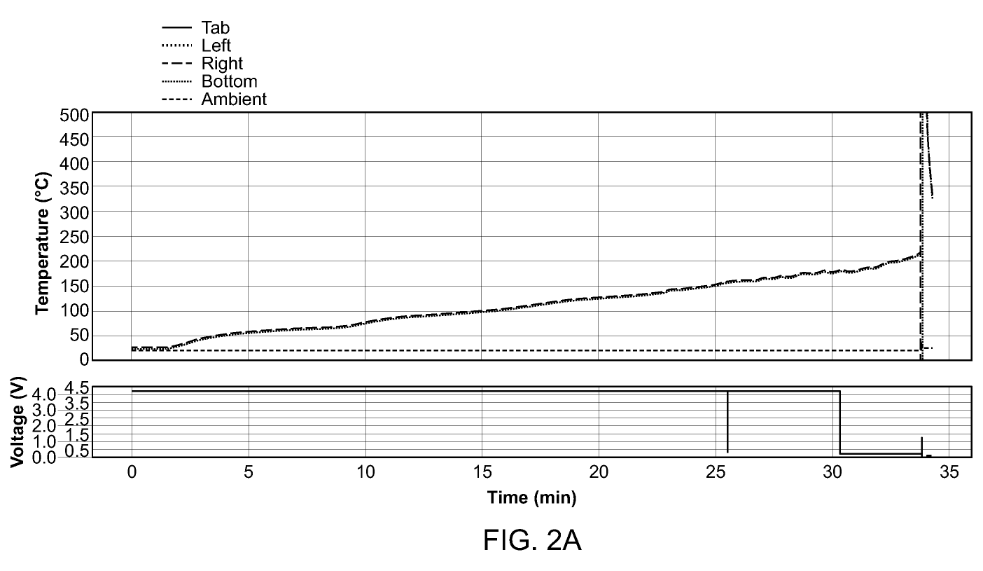

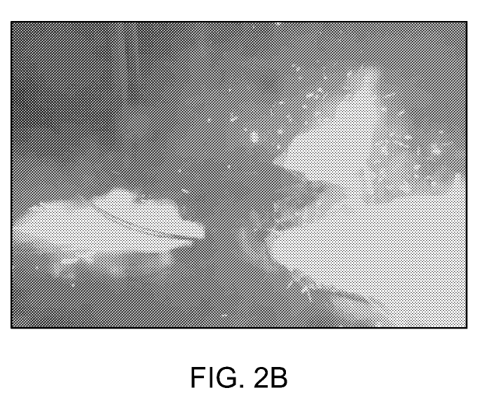

FIGS. 2A-5B show the results of abuse testing done on four different LMB cells, where three had different coatings and one was a control with no coating. Each of the four LMB cells comprised a NCM811 cathode (comprising about 98% active material, about 1% carbon nanotubes (CNTs), and about 1% binder) with an aluminum current collector, a lithium-foil anode with a copper current collector, and a polyethylene (PE) separator, was charged to 4.3V with a constant current rate of 0.2C and taper off to 0.05C, and had a capacity of 4 Ah. LMBs were placed in between metal clamping jigs to simulate actual use conditions, and were then wrapped with heat-insulating foams and heated up on a 5°C/min ramp until thermal runaway. Experiment videos, cell voltage, and heating ramp curves showing cell temperature and thermal runaway trigger temperature were recorded. FIGS. 2A, 3A, 4A, and 5A are graphs showing cell voltage and heating ramp curves including cell temperature and thermal runaway trigger for each of the four LMBs, and FIGS. 2B, 3B, 4B, and 5B are pictures/still-frames from each of the four experiment videos.

FIGS. 2A and 2B show results of abuse testing done on the control LMB, which did not have a coating. FIG. 2A shows that without any coating, the control LMB went to thermal runaway at about 232˚C, and FIG. 2B shows that a HL7 strong explosion occurred. These results indicate inadequate thermal instability of the control.

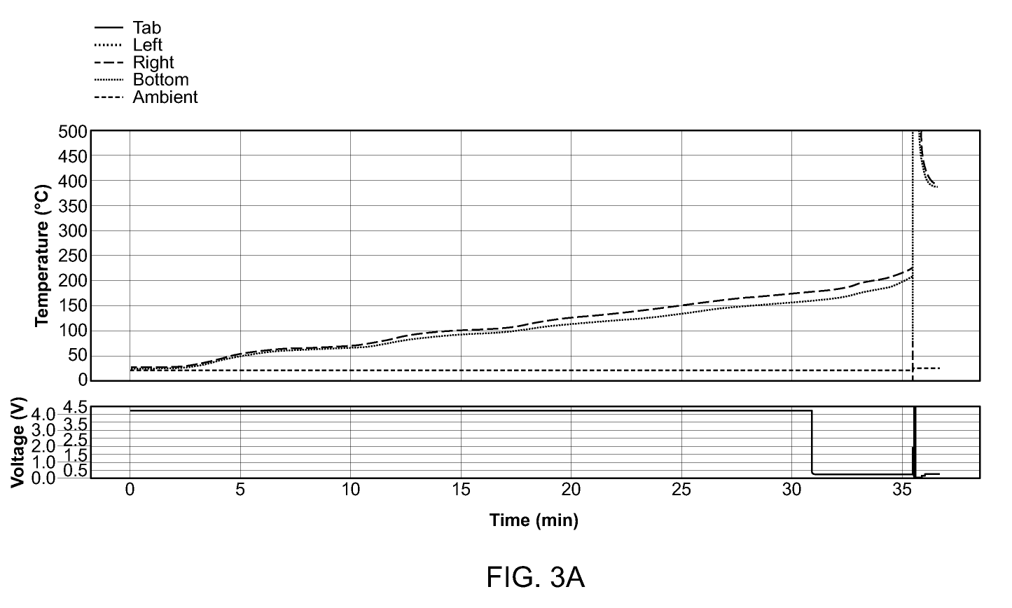

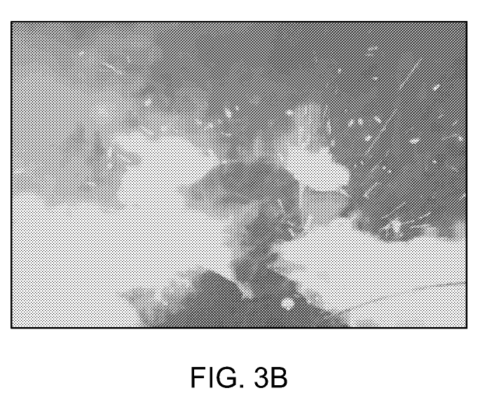

FIGS. 3A and 3B show results of abuse testing done on an LMB with a first coating. The first coating comprised boehmite, had a thickness of about 4 um, and was on the cathode-facing side of the PE separator. The LMB with the first coating showed no improvement in terms of thermal runaway trigger temperature and only a minimal improvement in terms of explosion severity, as it went to thermal runaway at about 224.4 ˚C (FIG. 3A) and had an HL between HL6 and HL7 (FIG. 3B).

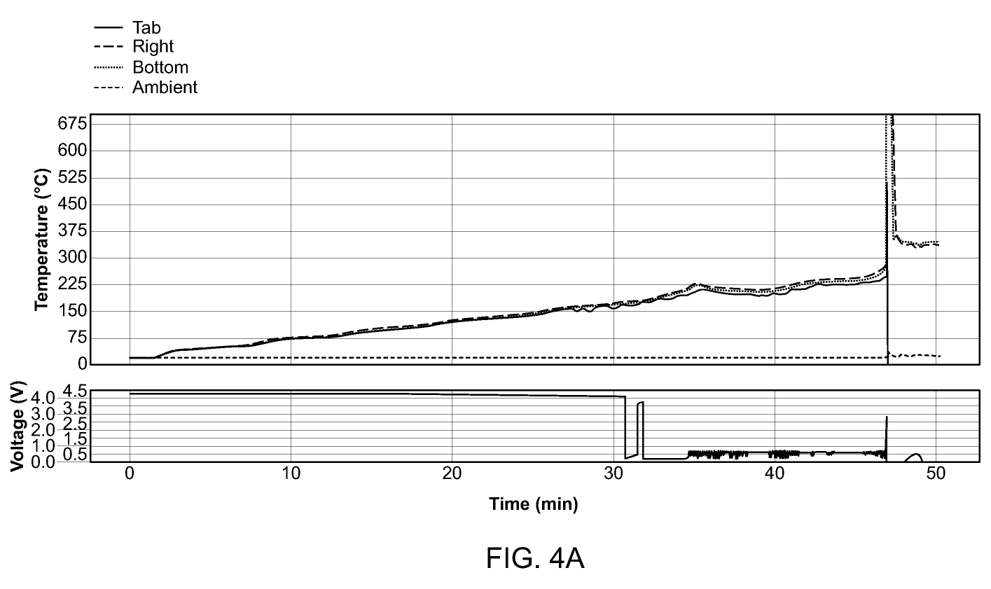

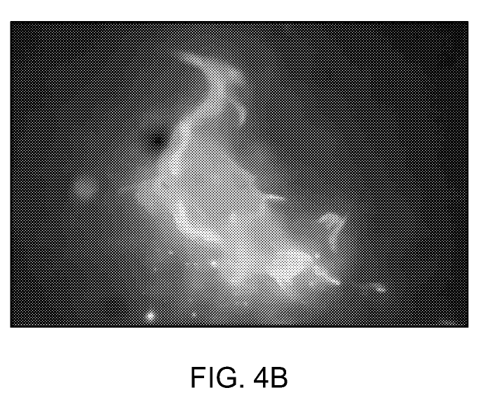

FIGS. 4A and 4B show results of abuse testing done on an LMB with a second coating. The second coating comprised aluminum oxide, had a thickness of about 4 um, and was on the cathode-facing side of the PE separator. The LMB with the second coating showed some improvements in terms of thermal runaway trigger temperature and explosion severity, as it went to thermal runaway at about 281.1˚C (FIG. 4A) and had an HL of HL6 (FIG. 4B).

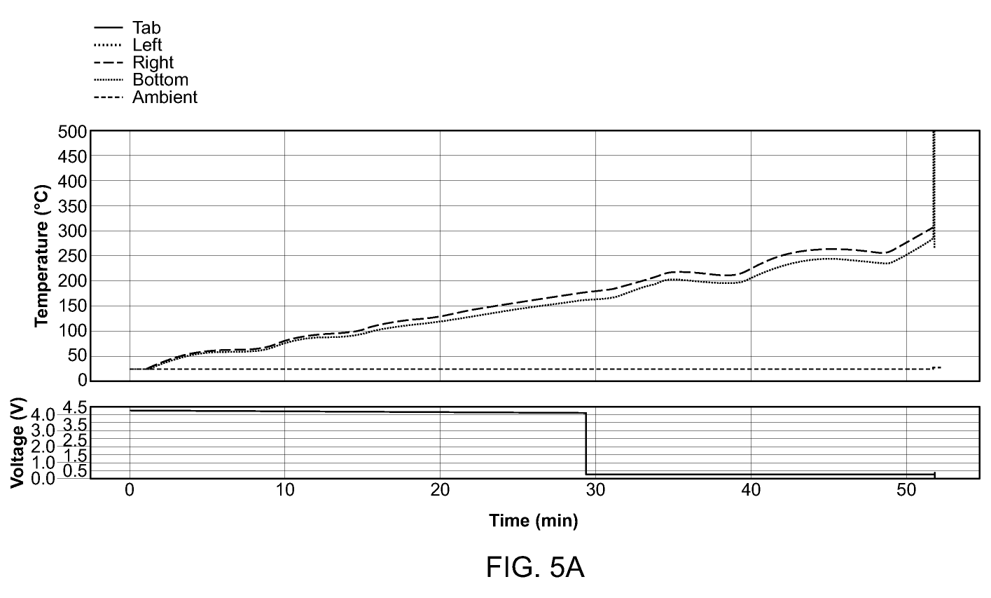

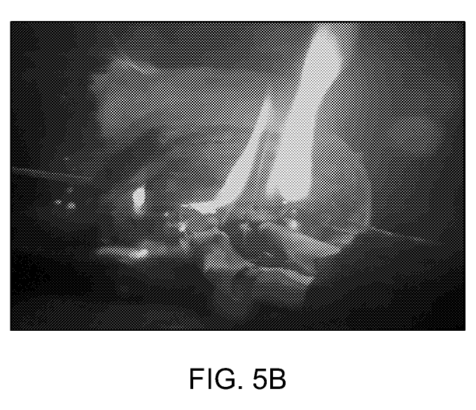

FIGS. 5A and 5B show results of abuse testing done on an LMB with a third coating. The third coating comprised aluminum oxide, had a thickness of about 2 um, and was on the outer surface of the cathode-active material. FIG. 5A shows that with the third coating, the thermal runaway trigger temperature rose to over 300˚C, and FIG. 5B shows that the HL reduced to a HL5 fire.

Test results indicate that without any protective elements, LMBs’ thermal stability is problematic. Even with coatings on the cathode-facing side of the PE separator (like the first coating and the second coating), thermal stability continued to be problematic. The best results came from the third coating that was directly on the cathode, indicating the third coating’s unique advantage over the traditional approach of applying a ceramic coating (like the first coating and the second coating) to the separator.

In some aspects, the present disclosure is directed to methods of manufacturing coated cathodes. In some embodiments, methods comprise combining a plurality of particles, one or more binders, and one or more solvents to form a precursor, followed by applying the precursor directly to a cathode-active material of a cathode, and removing the one or more solvents so as to cause the particles and one or more binders to form a coating on the cathode-active material. The particles may comprise a metal oxide (such as aluminum oxide, zirconium oxide, magnesium oxide, or any other thermally stable oxide), silicon dioxide, a silicate, an inorganic carbide (such as silicon carbide or boron carbide), and/or a metal nitride (such as silicon nitride or aluminum nitride).

In some embodiments, applying the precursor directly to the cathode-active material comprises using a height-controlled coating roller to apply the precursor directly to the cathode-active material. In some embodiments, removing the one or more solvents comprises drying the applied precursor under vacuum at about 80°C to about 130°C for about 4 hours to about 24 hours. In some embodiments, removing the one or more solvents comprises drying the applied precursor under vacuum at about 120°C for about 8 hours. Methods of manufacturing coated cathodes may further comprise grinding the precursor before applying it to the cathode-active material. Quality of the coating may be controlled by adjusting thickness, uniformity, density, porosity, surface roughness, and bulk properties of the coating. Because these characteristics can be adjusted, intrinsic safety can be improved with minimal impacts on cell design and performance.

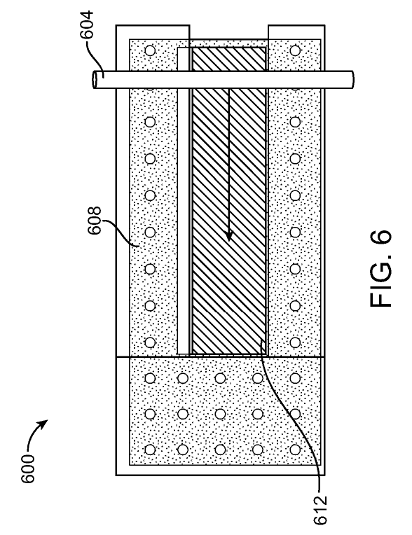

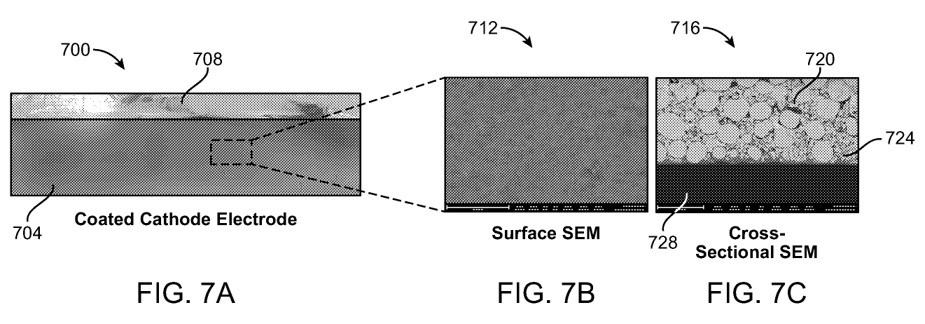

FIG. 6 shows one example method 600 of manufacturing a coated cathode. In this example, the method 600 comprises combining a plurality of aluminum oxide particles (purity≥99.9%, D₉₀=0.699, specific surface area≤20 m²/g, pH=8.61), a binder consisting of PVDF, and solvents consisting of dimethylformamide (DMF) and N-methyl-2-pyrrolidone (NMP) to form a precursor (not shown); grinding the precursor (not shown) to a D₉₀ value ranging from about 0.1 µm to about 5 µm; setting a coating roller 604 to a controlled height to achieve a coating areal density of about 1mg/cm² and a coating thickness of about 2.8±0.4 µm; applying a thin polyethylene terephthalate (PET) film covering 608 (with a thickness ranging from about 2 µm to about 100 µm) around the edges of a cathode 612 to prevent or minimize any extra coating or unevenness on the edges of the cathode; applying the precursor to the outer surface of the cathode-active material of the cathode 612; fine-tuning the speed and direction of the coating roller 604 to achieve a substantially uniform coating morphology (see FIGS. 7A-7C); and drying the coated cathode 612 under vacuum at about 120°C for about 8 hours so as to remove the DMF and NMP and cause the aluminum oxide particles and PVDF to form a coating on the cathode-active material (see FIGS. 7A-7C).

FIGS. 7A through 7C show the resulting coated cathode 700 from completing the method 600. As shown in FIG. 7A, the coated cathode 700 comprises a current collector 704 in electrical communication with a coated cathode-active material 708. FIG. 7B is a surface scanning electron microscopy (SEM) scan 712 showing the coated surface of the coated cathode-active material 708, which can be seen as having uniform surface morphology and low roughness. FIG. 7C is a cross-sectional SEM scan 716 of the coated cathode 700 showing the aluminum-oxide particles 720 (only one labeled to avoid clutter), PVDF 724, and cathode-active material 728. The aluminum-oxide particles 720 are uniformly distributed, and the porosity ranges from about 5% to about 50%.

In some aspects, the present disclosure is directed to electrochemical cells comprising at least one cathode that includes a coating having any one or more properties of coatings described above. FIG. 8 illustrates a simplified electrochemical energy-storage cell 800 made in accordance with aspects of the present disclosure. Those skilled in the art will readily appreciate that the electrochemical energy-storage cell 800 can be, for example, a battery or a supercapacitor. In addition, those skilled in the art will readily understand that FIG. 8 illustrates only some basic functional components of the electrochemical energy-storage cell 800 and that a real-world instantiation of the electrochemical energy-storage cell, such as a secondary battery or a supercapacitor, will typically be embodied using either a wound construction or a stacked construction. Further, those skilled in the art will understand that the electrochemical energy-storage cell 800 will include other components, such as electrical terminals, seal(s), thermal shut-down layer(s), and/or vent(s), among other things, that, for ease of illustration, are not shown in FIG. 8.

In this example, the electrochemical energy-storage cell 800 includes a spaced-apart cathode 804 and anode 808, and a pair of corresponding respective current collectors 804A, 808A. A porous separator 812 is located between the cathode 804 and the anode 808 to electrically separate the cathode and the anode but to allow ions of an electrolyte 816 to flow therethrough. The porous separator 812 and/or one, the other, or both of the cathode 804 and the anode 808, depending on whether porous or not, is/are impregnated with the electrolyte 816. In FIG. 8, both the cathode 804 and the anode 808 are illustrated as being porous by way of the electrolyte 816 being illustrated as extending into them. The electrochemical energy-storage cell 800 includes a container 820 that contains the current collectors 804A, 808A, the cathode 804 and the anode 808, the porous separator 812, and the electrolyte 816. FIG. 8 also shows the cathode 804 having a coating 824, which comprises a plurality of particles and one or more binders that bind the plurality of particles together. The particles may comprise a metal oxide (such as aluminum oxide, zirconium oxide, magnesium oxide, or any other thermally stable oxide), silicon dioxide, a silicate, an inorganic carbide (such as silicon carbide or boron carbide), and/or a metal nitride (such as silicon nitride or aluminum nitride). The one or more binders do not dissolve in the electrolyte 816. In some embodiments, the electrochemical energy-storage cell 800 is part of a greater battery system.

As those skilled in the art will understand, depending upon the type and design of the electrochemical energy-storage cell 800, each of the cathode 804 and the anode 808 comprises a suitable material compatible with the electrolyte 816. In some embodiments, the anode 808 comprises lithium metal as an anode-active material and the cathode 804 comprises nickel as a cathode-active material. Each of the current collectors 804A, 808A may be made of any suitable electrically conducting material, such as copper or aluminum, or any combination thereof. The porous separator 812 may be made of any suitable porous dielectric material, such as a porous polymer, among others.

Various battery and supercapacitor constructions that can be used for constructing the electrochemical energy-storage cell 800 of FIG. 8, are known in the art. If any of such known constructions is used, a novelty of the electrochemical energy-storage cell 800 lies in the coating 824 of the cathode 804. Those skilled in the art will readily appreciate that in stacked constructions made of a plurality of anodes stacked with a plurality of cathodes and a plurality of separators, each anode may have anode-active material on both sides of the corresponding current collector 808A.

In some aspects, the present disclosure is directed to methods of manufacturing an electrochemical energy-storage cell having a coated cathode. The electrochemical energy-storage cell and coated cathode may have any one or more of the properties of electrochemical energy-storage cells and coated cathodes described above. For example, in some embodiments, methods of manufacturing the electrochemical energy-storage cell 800 of FIG. 8 comprise combining a plurality of particles, one or more binders, and one or more solvents to form a precursor, applying the precursor to the cathode 804, and removing the one or more solvents so as to cause the particles and one or more binders to form a coating on the cathode, placing the anode 808 in the container 820, placing the porous separator 812 in the container on top of the anode, placing the coated cathode in the container on top of the porous separator, adding the electrolyte 816 to the container, and sealing the container. Placing various of these elements “on top” of each other is not meant to be limited to a particular direction in space—the electrochemical energy-storage cell may be assembled in any direction.

The coated cathodes and related electrochemical cells and methods described herein solve problems in the prior art by increasing the thermal stability of LMBs, including LMBs with high-nickel cathodes, while still allowing for production scalability and minimization of material costs.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A coated cathode, comprising:
a cathode comprising a current collector and a cathode-active material in electrical communication with the current collector, the cathode-active material defining an inner surface and an outer surface spaced apart from one another, wherein the inner surface faces the current collector; and
a coating on the outer surface of the cathode-active material, the coating consisting of:
a plurality of particles comprising at least one of a metal oxide, silicon dioxide, a silicate, an inorganic carbide, and a metal nitride; and
a binder binding the plurality of particles together with one another.

2. The coated cathode of claim 1, wherein the coating has a thickness in a range of about 1 µm to about 20 µm.

3. A coated cathode, comprising:
a cathode comprising a current collector and a cathode-active material in electrical communication with the current collector, the cathode-active material defining an inner surface and an outer surface spaced apart from one another, wherein the inner surface faces the current collector; and
a coating on the outer surface of the cathode-active material, the coating comprising:
a plurality of particles comprising at least one of a metal oxide, silicon dioxide, a silicate, an inorganic carbide, and a metal nitride; and
a binder, wherein the plurality of particles are bound together by the binder;
wherein the coating has a thickness that is greater than about 1 µm and less than or equal to about 20 µm.

4. The coated cathode of claim 3, wherein the cathode-active material comprises at least 70% nickel.

5. The coated cathode of claim 3, wherein the plurality of particles comprises aluminum oxide.

6. The coated cathode of claim 3, wherein the binder comprises at least one of polyvinylidene fluoride, carboxymethyl cellulose, styrene-butadiene rubber, polyether ether ketone, polyvinylpyrrolidone, and polyimide.

7. The coated cathode of claim 3, wherein the coating has a coating volume, and the coating has a porosity in a range of about 10% to about 90% of the coating volume.

8. The coated cathode of claim 3, wherein the coating has an areal density in a range of about 0.1mg/cm² to about 10mg/cm².

9. The coated cathode of claim 3, wherein the coating has a volumetric density in a range of about 0.05g/cm³ to about 100g/cm³.

10. The coated cathode of claim 3, wherein the coating consists of the plurality of particles and the binder.

11. An electrochemical energy-storage cell, comprising:
an anode;
a coated cathode comprising:
a cathode comprising a current collector and a cathode-active material in electrical communication with the current collector, the cathode-active material defining an inner surface and an outer surface spaced apart from one another, wherein the inner surface faces the current collector; and
a coating on the outer surface of the cathode-active material, the coating comprising:
a plurality of particles comprising at least one of a metal oxide, silicon dioxide, a silicate, an inorganic carbide, and a metal nitride; and
a binder, wherein the plurality of particles are bound together by the binder;
wherein the coating has a thickness that is greater than about 1 µm and less than or equal to about 20 µm;
a porous separator disposed between the anode and the coated cathode, the porous separator electrically insulating the anode and the coated cathode relative to one another;
a container that contains the anode, the coated cathode, and the porous separator; and
an electrolyte in contact with the anode and the coated cathode and permeating the porous separator.

12. The electrochemical energy-storage cell of claim 11, wherein the anode includes a current collector and an anode-active material in electrical communication with the current collector, and the anode-active material consists essentially of lithium metal.

13. The electrochemical energy-storage cell of claim 11, wherein the cathode-active material comprises at least 70% nickel.

14. The electrochemical energy-storage cell of claim 11, wherein the coating consists of the plurality of particles and the binder.

15. The electrochemical energy-storage cell of claim 11, wherein the plurality of particles comprises aluminum oxide.

16. The electrochemical energy-storage cell of claim 11, wherein the binder comprises at least one of polyvinylidene fluoride, carboxymethyl cellulose, styrene-butadiene rubber, polyether ether ketone, polyvinylpyrrolidone, and polyimide.

17. The electrochemical energy-storage cell of claim 11, wherein the coating has a coating volume, and the coating has a porosity in a range of about 10% to about 90% of the coating volume.

18. The electrochemical energy-storage cell of claim 11, wherein the coating has an areal density in a range of about 0.1mg/cm² to about 10mg/cm².

19. The electrochemical energy-storage cell of claim 11, wherein the coating has a volumetric density in a range of about 0.05g/cm³ to about 100g/cm³.

20. The electrochemical energy-storage cell of claim 11, wherein the current collector comprises at least one of copper and aluminum and the porous separator comprises polyethylene.
